(19) United States
(12) Patent Application Publication
(10) Pub. No.: US 2005/0096060 A1
(43) Pub. Date: May 5, 2005

(54) Base station for controlling use of reduced slot cycle mode of operation in a wireless network

(75) Inventors: Purva R. Rajkotia, Plano, TX (US); Paul Gilliland, Fairview, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 10/701,537

(22) Filed: Nov. 5, 2003

(51) Int. Cl. H04Q 7/20

(52) U.S. Cl. 455/450

(57) ABSTRACT

For use in a wireless network, a base station that controls use of the reduced slot cycle mode by mobile stations communicating with the base station. The base station comprises: i) a traffic monitor for monitoring message traffic levels handled by the base station; and ii) a reduced slot cycle controller for receiving traffic statistics information from the traffic monitor and determining whether use of the reduced slot cycle mode by the mobile stations communicating with the base station interferes with scheduling of paging message transmissions by the base station. The reduced slot cycle controller, in response to a determination that use of the reduced slot cycle mode by the mobile stations does interfere with the scheduling of paging message transmissions by the base station, causes the base station to transmit a first control message indicating that the reduced slot cycle mode is disabled in the base station.

### TECHNICAL FIELD OF THE INVENTION

The present invention is directed generally to wireless communication systems and, more specifically, to a base station that controls the use of the reduced slot cycle mode of operation by mobile stations in a wireless network.

### BACKGROUND OF THE INVENTION

Wireless communication systems have become ubiquitous in society. Business and consumers use a wide variety of fixed and mobile wireless terminals, including cell phones, pagers, Personal Communication Services (PCS) systems, and fixed wireless access devices (e.g., vending machine with cell phone capability). Wireless service providers continually try to create new markets for wireless devices and expand existing markets by making wireless devices and services cheaper and more reliable. The prices of wireless devices have decreased to the point where nearly everyone can afford them. To continue to attract new customers, wireless service providers are implementing new services, especially digital data services that, for example, enable a user (or subscriber) to browse the Internet and to send and receive e-mail.

Mobile stations (e.g., cell phones, PCS handsets, portable computers, telemetry devices, and the like) frequently operate from an external power source connected to the mobile station. When the external power source is not connected, an internal battery provides a limited period of operation. Mobile stations that operate from batteries for longer periods of time offer increased value to users and competitive advantages for service providers and equipment vendors.

The duration of mobile station battery operation has often been extended using techniques that lower power consumption when the mobile station is in an idle state and not transferring voice or data traffic. A mobile station may enable one or more power saving configurations when it is in the idle state. For instance, the mobile station may disable its transmitter during the idle state, decreasing the amount of power required for idle state operation. A mobile station may further reduce its idle state power requirements by enabling a slotted mode of operation with a base station.

A mobile station enters the idle state when the mobile station is turned ON, is synchronized with the system, and has no calls in progress. During the idle state, a mobile station actively listens to a paging channel for information which includes overhead messages, such as system parameter messages, as well as messages directly addressed to the mobile station from a base station. A mobile station in the idle state may operate from a battery or from an external power source.

During the idle state, the mobile station may communicate with a base station in a non-slotted or a slotted mode. A typical paging channel slot is an 80-millisecond time slot within a paging slot cycle. The paging slot cycle ranges from 16 time slots (1.28 seconds) to 2048 time slots (163.84 seconds). In the non-slotted mode, the mobile station monitors all paging channel slots for messages from the base station. In the slotted mode, the mobile station only monitors a selected subset of the paging channel slots for messages from the base station. During time periods when the mobile station is not monitoring the selected subset of paging channel slots, power is turned OFF to the receiver circuits in the mobile station in order to save additional power. A mobile station extends the battery supply operating life by entering a slotted mode of operation with the base station because the mobile station receiver consumes power only during selected slot cycles rather than across the entire paging cycle.

In earlier wireless networks, such as Release B of cdma2000 (i.e., IS-2000-B), the mobile station could select a full slot cycle index, r, between 0 and 7 (i.e., 000-111). The slot cycle index, r, gives the period, P, of the slotted mode of operation according to the equation:
P=(2)^{r}×1.28 seconds [Eqn. 1]
Thus, for example, if the full slot cycle index, r, is 0, the period of the slotted mode is 1.28 seconds. If the full slot cycle index, r, is 1, the period of the slotted mode is 2.56 seconds. If the full slot cycle index is 2, the period of the slotted mode is 5.12 seconds, and so forth. Finally, if the full slot cycle index, r, is 7, the period of the slotted mode is 163.84 seconds.

However, the latest generation of wireless terminals, particularly cell phones and other mobile stations, incorporate new features and applications that require very fast messaging. Many of these new features cannot operate with full cycle slotted mode periods of 1.28 seconds or greater. For example, many cell phones and other wireless mobile stations (e.g., Palm Pilot) support interactive gaming applications that enable the operator of one mobile station to play against the operator of another mobile station. However, a gaming application that requires fast, real-time interactions cannot properly operate in a slotted mode that has a minimum period of 1.28 seconds.

Another new application that is adversely affected by full cycle slotted mode operation is Push-to-Talk service, such as the Direct Connect^{SM} service available from Nextel. A Push-to-Talk service allows two mobile stations to operate as walkie-talkies. A call connection is set up between a first mobile station and a second mobile station. After the call connection is established, the operators may let both mobile stations enter idle states. At any point in time, the operator of the first mobile station can simply press a button on the first mobile station and say, “Hey what are you up to?” and the operator of the second mobile station can hear the voice message immediately and respond. However, a Push-to-Talk application cannot properly operate with a slotted mode that has a minimum period of 1.28 seconds.

In order to perform fast messaging in gaming applications and Push-to-Talk services, the latest generation of mobile stations are capable of entering a reduced slot cycle mode (or negative slot cycle mode) when the mobile station is in a slotted mode of operation. In reduced slot cycle mode, the mobile station selects a reduced slot cycle index, r, between −4 and 7. As before, the slot cycle index, r, gives the period, P, of the slotted mode of operation according to the equation:
P=(2)^{r}×1.28 seconds [Eqn. 2]
Because the slot cycle index, r, can be a negative value, slot cycle periods of less than 1.28 seconds are possible. For example, if the reduced slot cycle index, r, is −4, the reduced slot cycle period of the slotted mode is 80 milliseconds. If the reduced slot cycle index, r, is −3, the reduced slot cycle period of the slotted mode is 160 milliseconds. If the reduced slot cycle index is −2, the reduced slot cycle period of the slotted mode is 320 milliseconds, and so forth.

Unfortunately, the widespread use of reduced slot cycle mode by a large number of mobile stations creates considerable scheduling problems in the base station. When paging slot cycles are 1.28 seconds or greater, the base station has the luxury of being able to flexibly schedule the transmission of paging messages to nearby mobile stations. However, when slot cycles are only 80 milliseconds long, the base station is less able to schedule transmissions in an optimal manner. Under some heavily loaded conditions, the benefits of shorter paging cycles become reduced.

Therefore, there exists a need for improved systems and methods of controlling the use of reduced slot cycle mode of operation by mobile stations in a wireless network.

### SUMMARY OF THE INVENTION

The present invention provides the base station with the flexibility to enable or disable (i.e., turn on or off) the reduced slot cycle (or the negative slot cycle) mode for the paging channel. The present invention uses a flag indicator on the overhead channel or the traffic channel to turn on or turn off the reduced slot cycle capability. The present invention thereby gives control to the base station as to when the reduced slot-cycle will be used. This is particularly useful in heavy traffic conditions, in which allowing lots of mobiles to operate in reduced slot cycle mode might impact the overall network performance.

According to the principles of the present invention, once the threshold of base station capacity is reached, the base station set the flag indicator to OFF. This prevents additional users from entering the reduced slot cycle index, consuming base station resources, and adversely impacting the battery life of other mobile stations.

To address the above-discussed deficiencies of the prior art, it is a primary object of the present invention to provide, for use in a wireless network, a base station capable of controlling the use of the reduced slot cycle mode by mobile stations communicating with the base station. According to an advantageous embodiment of the present invention, the base station comprises: i) a traffic monitor capable of monitoring message traffic levels handled by the base station; and ii) a reduced slot cycle controller capable of receiving traffic statistics information from the traffic monitor and determining whether use of the reduced slot cycle mode by the mobile stations communicating with the base station interferes with scheduling of paging message transmissions by the base station.

According to one embodiment of the present invention, the reduced slot cycle controller, in response to a determination that the use of the reduced slot cycle mode by the mobile stations does interfere with the scheduling of paging message transmissions by the base station, causes the base station to transmit a first control message indicating that the reduced slot cycle mode is disabled in the base station.

According to another embodiment of the present invention, the first control message is transmitted in an overhead channel.

According to still another embodiment of the present invention, the first control message is transmitted in a traffic channel.

According to yet another embodiment of the present invention, the first control message causes a selected target mobile station already operating in the reduced slot cycle mode to switch to operating in the full slot cycle mode.

According to a further embodiment of the present invention, the first control message causes new mobile stations accessing the base station to operate only in the full slot cycle mode.

According to a still further-embodiment of the present invention, the reduced slot cycle controller is further capable of causing the base station to transmit a second control message to a selected target mobile station operating in the full slot cycle mode, the second control message causing the selected target mobile station to switch to operating in the reduced slot cycle mode.

According to a yet further embodiment of the present invention, the reduced slot cycle controller causes the base station to transmit the second control message based on a quality of service level associated with the selected target mobile station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which base stations control the use of the reduced slot cycle mode of operation by mobile stations according to the principles of the present invention;

FIG. 2 illustrates in greater detail an exemplary base station according to one embodiment of the present invention;

FIG. 3 illustrates an exemplary wireless mobile station according to an advantageous embodiment of the present invention; and

FIG. 4 is a flow diagram illustrating the operation of the reduced slot cycle mode in the wireless network according to one embodiment of the present invention.

### DETAILED DESCRIPTION OF THE INVENTION

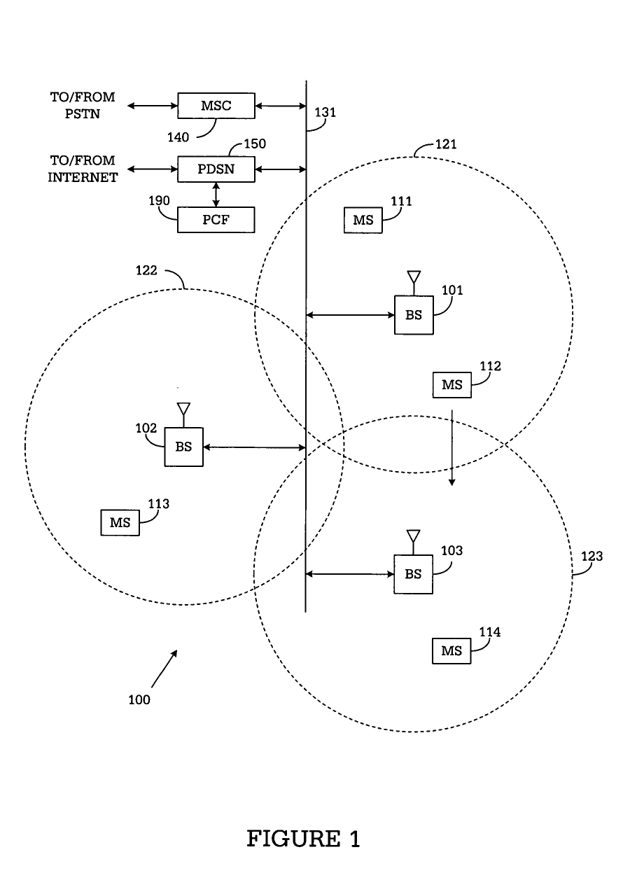

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100 in which base stations control the use of the reduced slot cycle mode of operation by mobile stations according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000-C standard (i.e., Release C of cdma2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

According to the principles of the present invention, the mobile stations operating in wireless network 100 are capable of operating in a reduced slot cycle mode of operation (also called a negative slot cycle mode of operation). However, in order to prevent the use of the reduced slot cycle mode of operation from interfering with the optimal scheduling of paging messages on the paging channel, base stations 101-103 of wireless network 100 are capable of enabling and disabling the use of the reduced slot cycle mode of operation by some or all of mobile stations 111-114. Base stations 101-103 turn the reduced slot cycle capability on or off by setting a flag indicator in an overhead channel (e.g., paging channel) or, alternatively, in a selected traffic channel. According to one embodiment of the present invention, once a predetermined threshold level of mobile station traffic is reached by a base station, the base station sets the flag indicator to OFF. This prevents additional mobile stations from entering the reduced slot cycle mode of operation.

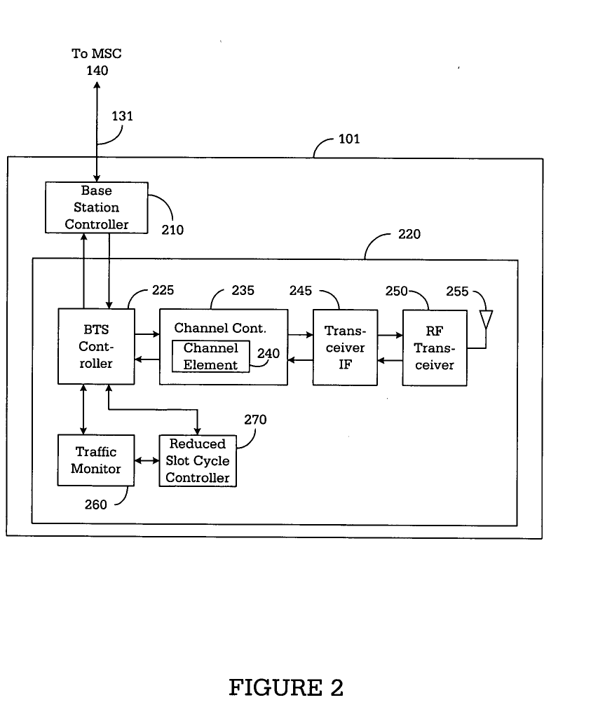

FIG. 2 illustrates exemplary base station 101 in greater detail according to one embodiment of the present invention. Base station 101 comprises base station controller (BSC) 210 and base transceiver subsystem (BTS) 220. Base station controllers and base transceiver subsystems were described previously in connection with FIG. 1. BSC 210 manages the resources in cell site 121, including BTS 220. BTS 220 comprises BTS controller 225, channel controller 235, transceiver interface (IF) 245, RF transceiver unit 250, and antenna array 255. Channel controller 235 comprises a plurality of channel elements, including exemplary channel element 240. BTS 220 also comprises traffic monitor 260 and reduced slot cycle controller 270.

BTS controller 225 comprises processing circuitry and memory capable of executing an operating program that communicates with BSC 210 and controls the overall operation of BTS 220. Under normal conditions, BTS controller 225 directs the operation of channel controller 235, which contains a number of channel elements, including channel element 240, that perform bi-directional communications in the forward channels and the reverse channels. A forward channel refers to a channel in which signals are transmitted from the base station to the mobile station. A reverse channel refers to a channel in which signals are transmitted from the mobile station to the base station. In an advantageous embodiment of the present invention, the channel elements communicate according to a code division multiple access (CDMA) protocol with the mobile stations in cell 121. Transceiver IF 245 transfers the bi-directional channel signals between channel controller 240 and RF transceiver unit 250.

Antenna array 255 transmits forward channel signals received from RF transceiver unit 250 to mobile stations in the coverage area of BS 101. Antenna array 255 also sends to transceiver 250 reverse channel signals received from mobile stations in the coverage area of BS 101. In a preferred embodiment of the present invention, antenna array 255 is a multi-sector antenna, such as a three-sector antenna in which each antenna sector is responsible for transmitting and receiving in a 120° arc of coverage area. Additionally, RF transceiver 250 may contain an antenna selection unit to select among different antennas in antenna array 255 during transmit and receive operations.

According to an exemplary embodiment of the present invention, traffic monitor 260 and reduced slot cycle controller 270 are capable of restricting use of the reduced slot cycle mode by mobile stations 111-114. Traffic monitor 260 is associated with BTS controller 225 and monitors the number of mobile stations handled by BS 101, the amount of voice and data traffic handled by BS 101, and the number of mobile stations operating in reduced slot cycle mode. Reduced slot cycle controller 270 receives the monitored traffic statistics from traffic monitor 260 and compares the traffic statistics to one or more predetermined threshold parameters. If reduced slot cycle controller 270 determines that the traffic load handled by base station 101 is interfering with the optimal scheduling of paging messages in the paging channel, reduced slot cycle controller 270 restricts the use of reduced slot cycle mode by causing BTS controller 225 to transmit a control message containing a flag indicator in an overhead channel (e.g., paging channel) or, alternatively, in a selected traffic channel.

According to the principles of the present invention, base station 101 may add a flag to an overhead message (e.g., system parameters message, extended system parameters message) or a traffic channel message (e.g., ITSPM, UHDM, GHDM) to indicate whether or not base station 101 supports the reduced slot cycle mode. Even if a mobile station informs base station 101 that the mobile station supports this capability, base station 101 can still override the mobile station capability and force the mobile station to work in the normal (or full slot cycle) mode of operation.

According to an exemplary embodiment, base station 101 indicates in the overhead messages that base station 101 supports reduced slot cycle mode of operation by initially enabling the flag indicator. Thus, any mobile station is initially capable of invoking the reduced slot cycle index feature. Thereafter, base station 101 schedules the transmission of messages in the paging channel accordingly to the slot cycle indexes assigned. If the number of mobile stations in base station 101 increases beyond the predetermined threshold(s), base station 101 turns off the flag indicator. After that point, other mobile stations entering the base station operate in full slot cycle mode. In this manner, the present invention can throttle the load of reduced slot cycle users.

According to an advantageous embodiment of the present invention, base station 101 is capable of restricting the use of the reduced slot cycle mode of operation by selected individual mobile stations, instead of restricting all new or existing mobile stations. To accomplish this, reduced slot cycle controller 270 causes BTS controller 225 to transmit to a target mobile station an individual traffic channel message (e.g., ITSPM, UHDM, GHDM) in which the flag indicator is disabled. When the target mobile station receives the traffic channel message, the target mobile station detects that the flag indicator is disabled and the target mobile station will only operate in full slot cycle mode thereafter.

This ability to disable the reduced slot cycle mode in individual mobile stations gives reduced slot cycle controller 270 tremendous flexibility in throttling the use of reduced slot cycle mode. The setting of the flag indicator can be made dependent on the other characteristics, such as quality of service (QoS), mobile station priority (i.e., high paying customers), and the like. Thus, base station 101 can use a system parameters control message to restrict the use of reduced slot cycle mode by new mobile stations entering the coverage area of base station 101, while at the same time allowing existing mobile station to continue to use the reduced slot cycle mode. Additionally, base station 101 can use a system parameters control message or a traffic channel control message to restrict the use of reduced slot cycle mode by selected existing mobile stations, while at the same time allowing other existing mobile station to continue to use the reduced slot cycle mode.

In FIG. 2, reduced slot cycle controller 270 and traffic monitor 260 are associated with base transceiver subsystem 220. It should be understood that this configuration is by way of illustration only and should not be construed to limit the scope of the present invention. Those skilled in the art will understand that in other embodiments, reduced slot cycle controller 270 and traffic monitor 260 may be associated with base station controller 210. in still other embodiments, reduced slot cycle controller 270 and traffic monitor 260 may be associated with both BTS 220 and BSC 210. What is essential is that traffic monitor 260 be able to monitor the traffic loading of one or more of the base transceiver subsystems associated with a base station controller 210 and that reduced slot cycle controller 270 be able to cause base station 101 to transmit an overhead channel message (e.g., system parameters message, extended system parameters message) or a traffic channel message (e.g., ITSPM, UHDM, GHDM) in which the flag is enabled or disabled.

Additionally, the present invention does not require reduced slot cycle controller 270 to use particular algorithm(s) or predetermined threshold(s) in order to restrict use of the reduced slot cycle mode. In fact, it is believed that such algorithm(s) or predetermined threshold(s) will vary widely from vendor to vendor and from deployment to deployment, depending on the physical capabilities of each base station and the environment in which each base station operates.

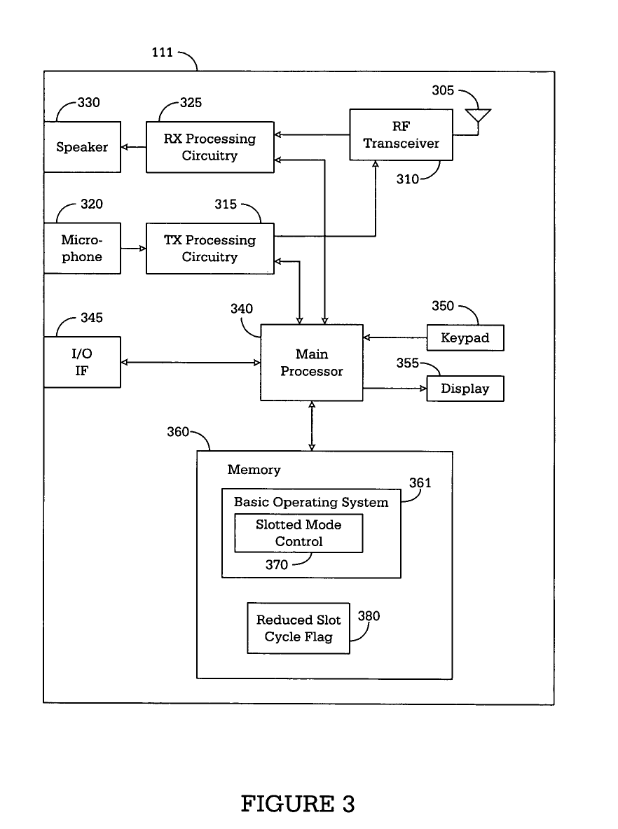

FIG. 3 illustrates wireless mobile station 111 according to an advantageous embodiment of the present invention. Wireless mobile station 111 comprises antenna 305, radio frequency (RF) transceiver 310, transmit (TX) processing circuitry 315, microphone 320, and receive (RX) processing circuitry 325. MS 111 also comprises speaker 330, main processor 340, input/output (I/O) interface (IF) 345, keypad 350, display 355, and memory 360. Memory 360 further comprises basic operating system (OS) program 361, slotted mode control algorithm 370, and reduced slot cycle flag field 380.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In an advantageous embodiment of the present invention, main processor 340 is a microprocessor or microcontroller. Memory 360 is coupled to main processor 340. According to an advantageous embodiment of the present invention, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless mobile station 111. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. Main processor 340 is also coupled to I/O interface 345. I/O interface 345 provides mobile station 111 with the ability to connect to other devices such as laptop computers and handheld computers. I/O interface 345 is the communication path between these accessories and main controller 340.

Main processor 340 is also coupled to keypad 350 and display unit 355. The operator of mobile station 111 uses keypad 350 to enter data into mobile station 111. Display 355 may be a liquid crystal display capable of rendering text and/or at least limited graphics from web sites. Alternate embodiments may use other types of displays.

Basic operating system 361 includes slotted mode control algorithm 370. According to the principles of the present invention, when mobile station 111 enters an idle state, main processor 340 may execute slotted mode control algorithm 370 and thereby enter a full slot cycle mode of operation or a reduced slot cycle mode of operation. Slotted mode control algorithm 370 checks the value stored in reduced slot cycle flag field 380 in order to determine whether to operate in full slot cycle mode or reduced slot cycle mode. Reduced slot cycle flag field 380 stores the value of the flag indicator transmitted by base station 101 in the overhead channel message or traffic channel message.

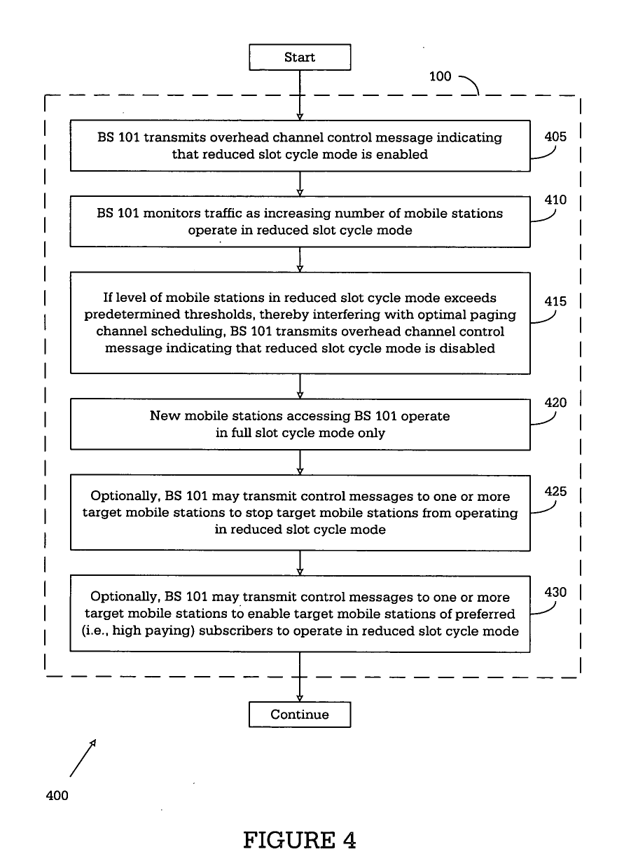

FIG. 4 depicts flow diagram 400, which illustrates the operation of the reduced slot cycle mode in wireless network 100 according to one embodiment of the present invention. Initially, base station 101 transmits an overhead channel control message indicating that the reduced slot cycle mode is enabled (process step 405). Base station 101 then monitors traffic as an increasing number of mobile stations operate in the reduced slot cycle mode (process step 410). At some point, if the level of mobile stations operating in the reduced slot cycle mode exceeds one or more predetermined thresholds (thereby interfering with optimal paging channel scheduling), base station 101 transmits an overhead channel control message indicating that the reduced slot cycle mode is disabled (process step 415). Thereafter, new mobile stations accessing base station 101 operate in the full slot cycle mode only (process step 420).

Optionally, base station 101 may transmit control messages to one or more target mobile stations already operating in the reduced slot cycle mode in order to stop those target mobile stations from continuing to operate in the reduced slot cycle mode (process step 425). Optionally, base station 101 also may transmit control messages to one or more target mobile stations to enable the target mobile stations of preferred (i.e., high paying) subscribers to operate in the reduced slot cycle mode (process step 430).

Although the present invention has been described with an exemplary embodiment, various changes and modifications may be suggested to one skilled in the art. It is intended that the present invention encompass such changes and modifications as fall within the scope of the appended claims.

1. For use in a wireless network, a base station capable of controlling the use of the reduced slot cycle mode by mobile stations communicating with said base station, said base station comprising:
a traffic monitor capable of monitoring message traffic levels handled by said base station; and
a reduced slot cycle controller capable of receiving traffic statistics information from said traffic monitor and determining whether use of said reduced slot cycle mode by said mobile stations communicating with said base station interferes with scheduling of paging message transmissions by said base station.

2. The base station as set forth in claim 1 wherein said reduced slot cycle controller, in response to a determination that said use of the reduced slot cycle mode by said mobile stations does interfere with said scheduling of paging message transmissions by said base station, causes said base station to transmit a first control message indicating that the reduced slot cycle mode is disabled in said base station.

3. The base station as set forth in claim 2 wherein said first control message is transmitted in an overhead channel.

4. The base station as set forth in claim 2 wherein said first control message is transmitted in a traffic channel.

5. The base station as set forth in claim 2 wherein said first control message causes a selected target mobile station already operating in the reduced slot cycle mode to switch to operating in the full slot cycle mode.

6. The base station as set forth in claim 2 wherein said first control message causes new mobile stations accessing said base station to operate only in the full slot cycle mode.

7. The base station as set forth in claim 6 wherein said reduced slot cycle controller is further capable of causing said base station to transmit a second control message to a selected target mobile station operating in the full slot cycle mode, said second control message causing said selected target mobile station to switch to operating in the reduced slot cycle mode.

8. The base station as set forth in claim 7 wherein said reduced slot cycle controller causes said base station to transmit said second control message based on a quality of service level associated with said selected target mobile station.

9. A wireless network comprising a plurality of base stations, each of said plurality of base stations capable of controlling the use of the reduced slot cycle mode by mobile stations communicating with said each base station, wherein said each base station comprises:
a traffic monitor capable of monitoring message traffic levels handled by said each base station; and
a reduced slot cycle controller capable of receiving traffic statistics information from said traffic monitor and determining whether use of said reduced slot cycle mode by said mobile stations communicating with said each base station interferes with scheduling of paging message transmissions by said each base station.

10. The wireless network as set forth in claim 9 wherein said reduced slot cycle controller, in response to a determination that said use of the reduced slot cycle mode by said mobile stations does interfere with said scheduling of paging message transmissions by said each base station, causes said each base station to transmit a first control message indicating that the reduced slot cycle mode is disabled in said each base station.

11. The wireless network as set forth in claim 10 wherein said first control message is transmitted in an overhead channel.

12. The wireless network as set forth in claim 10 wherein said first control message is transmitted in a traffic channel.

13. The wireless network as set forth in claim 10 wherein said first control message causes a selected target mobile station already operating in the reduced slot cycle mode to switch to operating in the full slot cycle mode.

14. The wireless network as set forth in claim 10 wherein said first control message causes new mobile stations accessing said each base station to operate only in the full slot cycle mode.

15. The wireless network as set forth in claim 14 wherein said reduced slot cycle controller is further capable of causing said each base station to transmit a second control message to a selected target mobile station operating in the full slot cycle mode, said second control message causing said selected target mobile station to switch to operating in the reduced slot cycle mode.

16. The wireless network as set forth in claim 15 wherein said reduced slot cycle controller causes said each base station to transmit said second control message based on a quality of service level associated with said selected target mobile station.

17. For use in a wireless network, a method of controlling the use of the reduced slot cycle mode by mobile stations communicating with a base station, the method comprising the steps of:
monitoring message traffic levels handled by the base station; and
determining from traffic statistics information gathered by the step of monitoring whether use of the reduced slot cycle mode by the mobile stations communicating with the base station interferes with scheduling of paging message transmissions by the base station.

18. The method as set forth in claim 17 further comprising the step, in response to a determination that the use of the reduced slot cycle mode by the mobile stations does interfere with the scheduling of paging message transmissions by the base station, of transmitting a first control message indicating that the reduced slot cycle mode is disabled in the base station.

19. The method as set forth in claim 18 wherein the first control message is transmitted in an overhead channel.

20. The method as set forth in claim 18 wherein the first control message is transmitted in a traffic channel.

21. The method as set forth in claim 18 wherein the first control message causes a selected target mobile station already operating in the reduced slot cycle mode to switch to operating in the full slot cycle mode.

22. The method as set forth in claim 18 wherein the first control message causes new mobile stations accessing the base station to operate only in the full slot cycle mode.

23. A mobile station for communicating with a base station of a wireless network, said mobile station capable of operating in a full slot cycle mode and a reduced slot cycle mode, wherein said mobile station is capable of receiving from said base station a first control message indicating that the reduced slot cycle mode is disabled in said base station and, in response to said first control message, said mobile station operates only in the full slot cycle mode.

24. The mobile station as set forth in claim 23 wherein said first control message causes said mobile station to switch from operating in the reduced slot cycle mode to operating in the full slot cycle mode.
